(19) United States
(12) Patent Application Publication
(10) Pub. No.: US 2013/0193895 A1
(43) Pub. Date: Aug. 1, 2013

(54) MOTOR CONTROL APPARATUS AND CONTROL METHOD THEREOF

(71) Applicants: Tomohiro Noguchi, Chiyoda-ku (JP); Toshiyuki Kaitani, Chiyoda-ku (JP)

(72) Inventors: Tomohiro Noguchi, Chiyoda-ku (JP); Toshiyuki Kaitani, Chiyoda-ku (JP)

(73) Assignee: MITSUBISHI ELECTRIC CORPORATION, Chiyoda-ku, Tokyo (JP)

(21) Appl. No.: 13/811,539

(22) PCT Filed: Jul. 26, 2010
(86) PCT No.: PCT/JP2010/004740

§ 371 Date: Apr. 4, 2013

(51) Int. Cl. H02P 29/02

(52) U.S. Cl. CPC H02P 29/022
USPC 318/490

(57) ABSTRACT

The second torque value and a motor speed detected from the motor in operation are compared to an upper limit and lower limit of torque tolerance which is obtained based on the third torque value. Accordingly, if the third torque value exceeds the upper limit or underruns the lower limit of the torque tolerance, the motor is stopped in accordance with a difference between the third torque value and the torque tolerance. Consequently, since abnormality of the motor can be promptly and accurately detected within an entire speed range including a lower speed range, it is effective for protecting the motor or the machine equivalent of a load for the motor.

### TECHNICAL FIELD

The present invention relates to motor control apparatuses in which functions for detecting abnormal torque during operation are provided.

### Background Art

Regarding motor control apparatuses, there are conventionally disclosed technologies in which torque is detected during operation and alarms etc. are outputted if a torque value is abnormal, for the purpose of preventing breakdowns of motors.

For example, a method shown in Patent Document 1 is as follows. Torque values when a motor is operated under a predetermined action pattern are acquired as initial values and are stored in a data memory. And then, torque values in an actual action are continuously compared to limit torque values stored in the data memory so that load conditions can be constantly monitored. Accordingly, an alarm is outputted if a torque value of the motor exceeds a limit torque value.

Also, another method shown in Patent Document 2 is as follows. A pattern for detecting abnormal torque is generated in advance based on a current command for an elapsed time corresponding to a door opening/closing action and a torque command pattern obtained from a speed command, and abnormality of the door is detected during actual operation if a torque command value exceeds the pattern for detecting the abnormal torque.

### PRIOR ART DOCUMENTS

### Patent Documents

Patent Document 1: Japanese Unexamined Patent Application Publication No. 2007-28865 (Page 4, Page 5, and FIG. 3)

Patent Document 2: Japanese Unexamined Patent Application Publication No. 2005-212963 (Page 10, Page 11, and FIG. 10)

### SUMMARY OF INVENTION

### Problem that the Invention is to Solve

However, in the above described technology according to Patent Document 1, there is a problem in which no alarm is outputted even when abnormal torque is generated having a level sufficiently smaller than a limit torque value, because abnormality is detected based on the maximum torque in the action pattern. As a result, a case may happen in which a machine is broken when abnormal torque is continuously generated having a level insufficient for operating an alarm output. For example, since load torque changes in response to the square of a speed at a reduced torque load, the load torque is small at a lower speed range. Therefore, there has been a problem that no alarm is outputted even when abnormal torque is generated at such a lower speed range.

In the above described technology according to Patent Document 2, because abnormality is detected when an actual torque value exceeds a torque command value by a certain value, there has been a problem in which no alarm is outputted for abnormality in which an actual torque value underruns a torque command value, such as a case in which torque is insufficiently loaded due to a physical breakage of a machine although the torque is to be loaded to the machine, or a case in which torque instantaneously decreases due to a reaction against an overload.

The present invention has been made under the consideration of the above described problems, and is to provide a motor control apparatus and a control method therefor which is effective for protecting a motor or a machine, that includes a trial operation step for obtaining torque values at respective speeds of the motor control apparatus and generating a table on motor speed values and torque values, and a subsequent operation step, a torque correction step, and an abnormal torque judging step for comparing a torque value detected in the operation step to a value in the table generated in the trial operation step so that abnormality of the motor or the machine equivalent of a load for the motor is detected.

### Means for Solving the Problem

The present invention is characterized by having a current/speed detector for detecting a current value flowing to a motor and a speed value of the motor; a torque calculator for calculating a torque value by using the detected current value; a table generator for generating a table based on speed values of the motor transferred from the current/speed detector and torque values outputted from the torque calculator; a torque correction unit for correcting the speed value of the motor detected by the current/speed detector and a torque value at the speed value to a torque value at a speed value of the motor, out of the speed values of the motor stored in the table, which is approximative to the detected speed value of the motor; and an abnormal torque judging unit for judging, by comparing the corrected torque value to the calculated torque value, whether or not the calculated torque value is an abnormal value.

### Advantageous Effects of the Invention

As described above, in a power converter according to the present invention, since abnormality of a motor can be promptly and accurately detected within an entire range of speeds including a lower speed range, it is effective for protecting the motor or a machine equivalent of a load for the motor.

### BRIEF DESCRIPTION OF DRAWINGS

FIG. 1 is a configuration diagram showing a motor control apparatus according to Embodiment 1 of the present invention.

FIG. 2 is a flow chart on a series of actions in the motor control apparatus for detecting abnormality of a motor or a machine equivalent of a load for the motor, according to Embodiment 1 of the present invention.

FIG. 3 is a flow chart showing an action in the motor control apparatus at a trial operation step, according to Embodiment 1 of the present invention.

FIG. 4 is a flow chart showing an action in the motor control apparatus at a data processing step, according to Embodiment 1 of the present invention.

FIG. 5 is a diagram showing a table generating method in the data processing step, according to Embodiment 1 of the present invention.

FIG. 6 is a flow chart showing an action in the motor control apparatus at an operation step, according to Embodiment 1 of the present invention.

FIG. 7 is a flow chart showing an action in the motor control apparatus at a torque correction step, according to Embodiment 1 of the present invention.

FIG. 8 is a flow chart showing an action in the motor control apparatus at an abnormal torque judging step, according to Embodiment 1 of the present invention.

FIG. 9 is a diagram showing an example of curves for representing a relationship among a torque-speed curve detected by the motor control apparatus, an upper limit and lower limit of a torque tolerance range for stopping due to an error, and an upper limit and lower limit of a torque tolerance range for outputting an alarm, according to Embodiment 1 of the present invention.

### MODE FOR CARRYING OUT THE INVENTION

### Embodiment 1

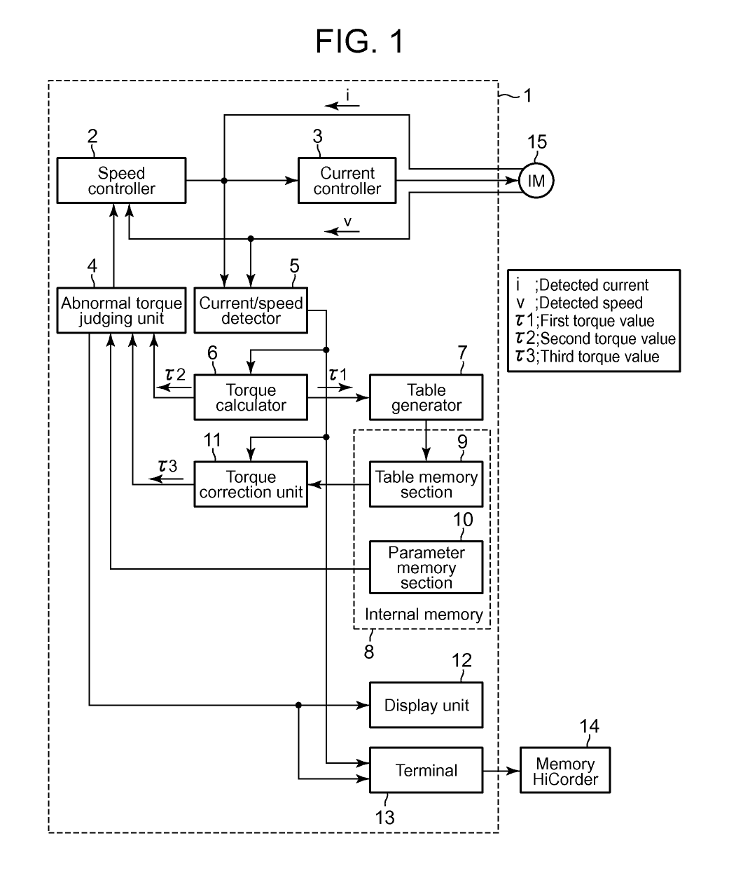

FIG. 1 is a configuration diagram showing a motor control apparatus according to Embodiment 1. Note that the present invention is not limited to Embodiment 1. In FIG. 1, a current/speed detector 5 in a motor control apparatus 1 detects current flowing from the motor control apparatus 1 to a motor 15 and a speed of the motor 15 at every predetermined sampling cycle. After that, a first torque value is obtained from a detected current value at a trial operation step and a second torque value is obtained from a detected current value at an operation step by a torque calculator 6. In addition, the speed of the motor 15 and the first torque value are outputted to a table generator 7 by the torque calculator 6. Here, the trial operation step is a step for detecting a motor speed and a torque value to determine a torque tolerance range of the motor 15 by the motor control apparatus 1, and the operation step is a step in which the motor 15 is operated by the motor control apparatus 1 based on parameters which are set in advance.

A table on speed values of the motor 15 and first torque values is generated by the table generator 7 based on the speeds of the motor 15 and the first torque values outputted by the torque calculator 6, and is outputted to a table memory section 9 in an internal memory 8. Here, the internal memory 8 includes the table memory section 9 for storing the table on speed values of the motor 15 and first torque values, and a parameter memory section 10 for storing parameters such as acceleration/deceleration times and motor constants which are necessary for driving the motor control apparatus 1 and parameters for abnormality detecting conditions.

First torque values at speed values which are nearest and second nearest to a speed value of the motor 15 obtained in the operation step are selected from values in the table in the table memory section 9 in a torque correction step by a torque correction unit 11, and are acquired from the table memory section 9. And then, a third torque value which acts as a basis for an abnormal torque judging value at the detected speed value of the motor 15 is obtained from the acquired two first torque values by using a linear approximation correction, and is outputted to an abnormal torque judging unit 4. An upper limit and lower limit of a torque tolerance at the motor speed are obtained by the abnormal torque judging unit 4, and a second torque value and a motor speed detected by the current/speed detector 5 while the motor 15 is in operation are compared to the upper limit and lower limit of the torque tolerance in an abnormal torque judging step based on abnormality detecting parameters stored in the parameter memory section 10. Consequently, when the second torque value detected in the operation step exceeds the upper limit or underruns the lower limit of the tolerance, the following processing is performed by the abnormal torque judging unit 4 according to the degree of difference between the detected second torque value and the tolerance. That is, when the difference between the upper limit or lower limit of the torque value and the detected second torque value is small, an output command for displaying an alarm is outputted to a display unit 11 and a terminal 12. Meanwhile, when it is judged that a breakdown of the motor 15 or the motor control apparatus 1 is concerned because the difference between the upper limit or lower limit of the torque value and the detected second torque value is large, a command for stopping the motor 15 is outputted to a speed controller 2 and an output command for displaying an error is outputted to the display unit 11 and the terminal 12. Here, the abnormality detecting parameters include, for example, an upper limit for outputting an alarm, a lower limit for outputting an alarm, an upper limit for stopping due to an error, and a lower limit for stopping due to an error.

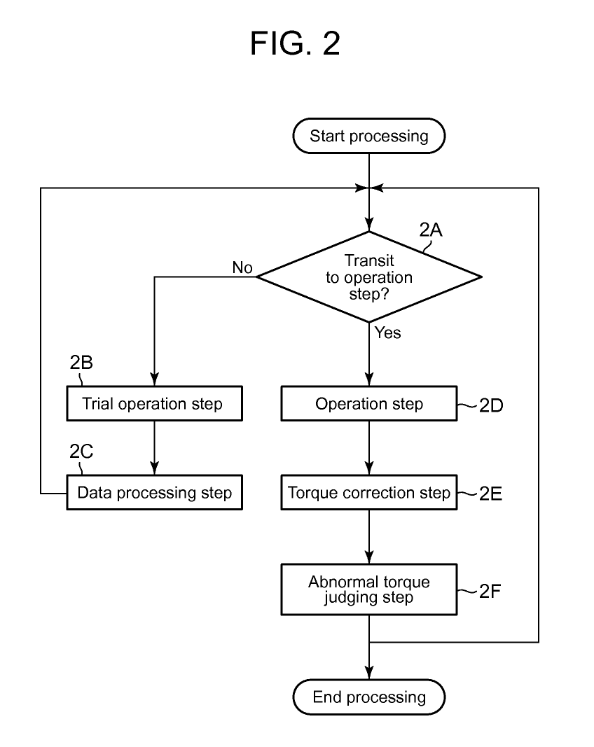

Hereinafter, a series of actions of the motor control apparatus 1 according to Embodiment 1 will be described based on a flow chart in FIG. 2. The actions include the trial operation step for obtaining torque values at respective speeds of the motor control apparatus and generating the table on motor speed values and torque values, and the subsequent operation step, the torque correction step, and the abnormal torque judging step for comparing the torque value detected in the operation step to a value in the table generated in the trial operation step so that abnormality of the motor or the machine equivalent of a load for the motor is detected.

First, making a transition to which one of the trial operation step (2B) or the operation step (2D) is automatically switched by a pre-installed control program in the motor control apparatus 1 in Step 2A in FIG. 2. Such processing may be achieved with a switchover in software by parameters selected by a user, or may be achieved with a switchover in hardware by arranging a selector switch in the motor control apparatus 1.

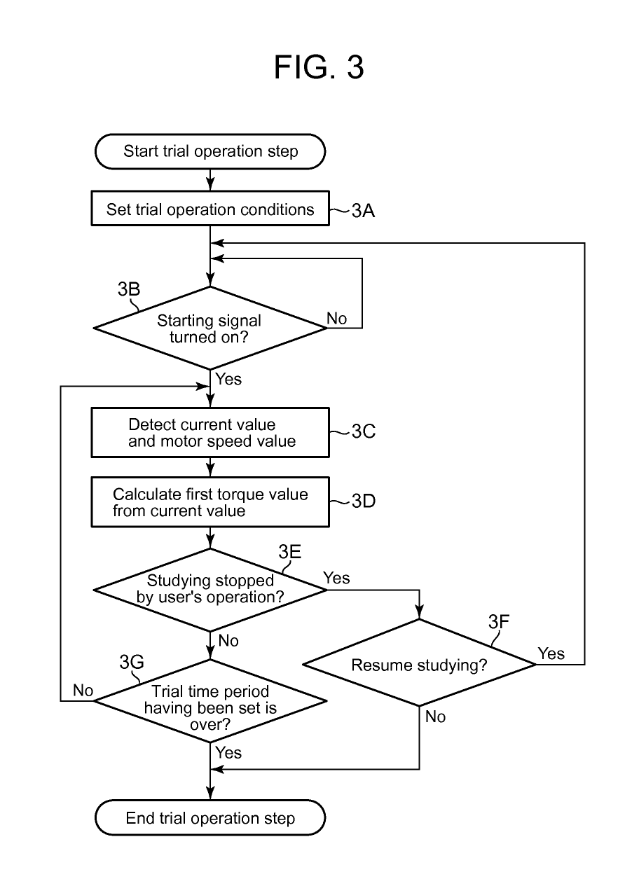

FIG. 3 shows a processing flow when a transition to the trial operation step (2B) is made in the above described action. First, trial operation conditions described below in the trial operation step are set by the user in Step 3A. That is, an operation pattern such as acceleration/deceleration times and operating frequencies of the motor are set, and then, a trial time period and a cycle for detecting a torque value and a motor speed (sampling cycle) in the operation pattern are set by the user. Here, which one of the number of trial operation times or the time for trial operation is to be specified as the trial time period can be switched by the user. Also, each of the number of trial operation times or the time for trial operation can be set to an arbitrary value within a predetermined configurable range.

After the completion of settings in Step 3A, by inputting a signal for starting the trial operation, for example turning on a starting signal by the user, in Step 3B, the motor is trially operated by the motor control apparatus 1 during a specified time period set in Step 3A and in accordance with the trial operation conditions likewise set in Step 3A. And then, a current value flowing to the motor and a speed value of the motor are detected in Step 3C by the current/speed detector 5 in accordance with the predetermined sampling cycle. Next, a first torque value is calculated in Step 3D from the detected current value flowing to the motor. Furthermore, even in the middle of the above described studying time period, the studying can be stopped, suspended, or resumed by user's operation (Step 3E, Step 3F), and even if the studying is stopped or suspended by the user, data of the speed values of the motor and the first torque values which have been detected is held. In addition, when the trial time period set in Step 3A is over, the trial operation step is completed (Step 3G).

The data of the speed values of the motor and the first torque values detected in the trial operation step can be outputted in real time from the terminal 13 arranged in the motor control apparatus 1, and the data can be checked by a measuring instrument such as a Memory HiCorder.

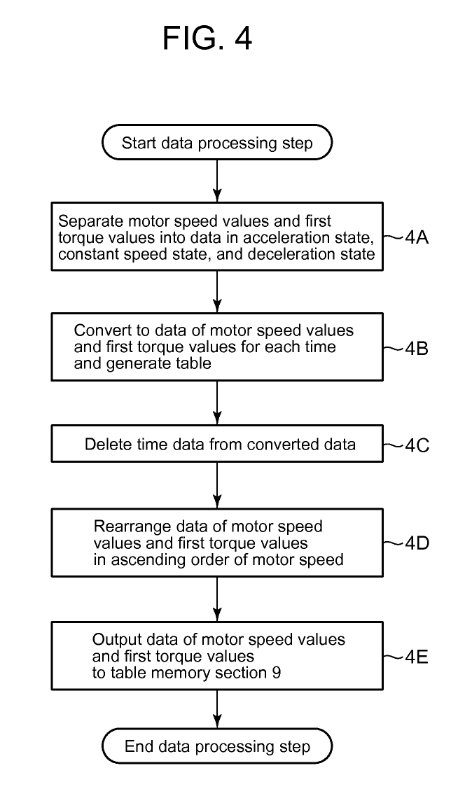

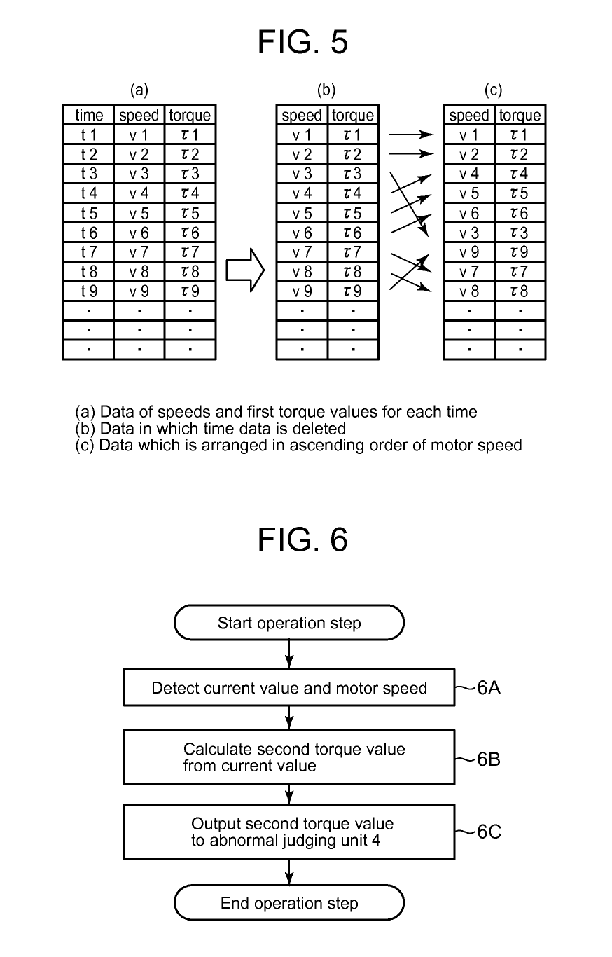

When the trial operation step (2B) is completed in FIG. 2, then a transition to a data processing step (2C) is made. FIG. 4 shows a detailed processing flow in the data processing step. First, the speed values of the motor and the first torque values are separated in Step 4A into data in an acceleration state, data in a constant speed state, and data in a deceleration state of the motor 15 by the table generator 7. Next, as shown in (a) of FIG. 5, a table on speed values of the motor and first torque values for each time is generated in Step 4B by the table generator 7 for each of the states, i.e. the acceleration state, constant speed state, and deceleration state, based on the speed values of the motor and the first torque values outputted from the current/speed detector 5. And then, as shown in (b) of FIG. 5, a set of data format, i.e. the detected speed values of the motor and the first torque values, is generated in Step 4C by the table generator 6 by deleting the time data from the table. After that, as shown in (c) of FIG. 5, the set of data is rearranged in Step 4D by the table generator 6 in ascending order of the motor speed. Finally, the data of the rearranged speed values of the motor and the first torque values is outputted to the table memory section 9 in Step 4E. As a result, the rearranged data is stored in the table memory section 9 being classified into the respective tables for the acceleration state, constant speed state, and deceleration state. As the completion of the above described processing, the data processing step (2C) is completed. After the completion of the data processing step (2C), it returns to Step 2A in FIG. 2.

Next, a processing when a transition to the operation step (2D) is made in Step 2A in FIG. 2 will be described. When the transition to the operation step is made, the motor 15 is driven by the motor control apparatus 1 based on parameters that are set in advance and stored in the parameter memory section 10 and that are necessary for the motor control apparatus 1 to drive the motor 15.

Hereinafter, processing by the motor control apparatus 1 in the operation step (2D) will be described by using FIG. 6. First, a current value flowing to the motor and a speed value of the motor are detected in Step 6A by the current/speed detector 5 in accordance with a predetermined sampling cycle. Next, after a second torque value is calculated in Step 6B by the torque calculator 6 from the detected current value flowing to the motor, the second torque value is outputted to the abnormal torque judging unit 4 in Step 6C and the operation step (2D) is completed.

The data of the speed values of the motor and the second torque values detected in the operation step can be outputted in real time from the terminal 13 arranged in the motor control apparatus 1, and the data can be checked by a measuring instrument such as a Memory HiCorder.

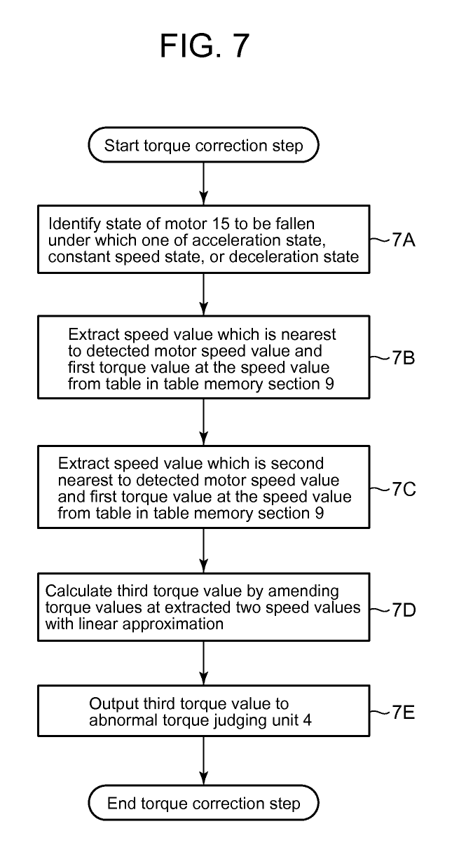

When the operation step (2D) is completed in FIG. 2, a transition to the torque correction step (2E) is made. Hereinafter, processing by the motor control apparatus 1 in the torque correction step (2E) will be described by using FIG. 7. First, it is identified in Step 7A that the state of the motor 15 falls under which one of the acceleration state, constant speed state, or deceleration state.

Next, a speed value which is nearest to the speed value of the motor detected in the operation step (2D) and a first torque value at the nearest speed value are extracted in Step 7B from the table stored in the table memory section 9 in the data processing step (2C). Also, a speed value which is second nearest to the speed value of the motor detected in the operation step (2D) and a first torque value at the second nearest speed value are extracted in Step 7C from the table stored in the table memory section 9 in the data processing step (2C).

And then, a third torque value at the speed value of the motor detected in the operation step is calculated in Step 7D by linearly approximating the respective first torque values which have been extracted. After that, the third torque value is outputted to the abnormal torque judging unit 4 in Step 7E and the torque correction step (2E) is completed.

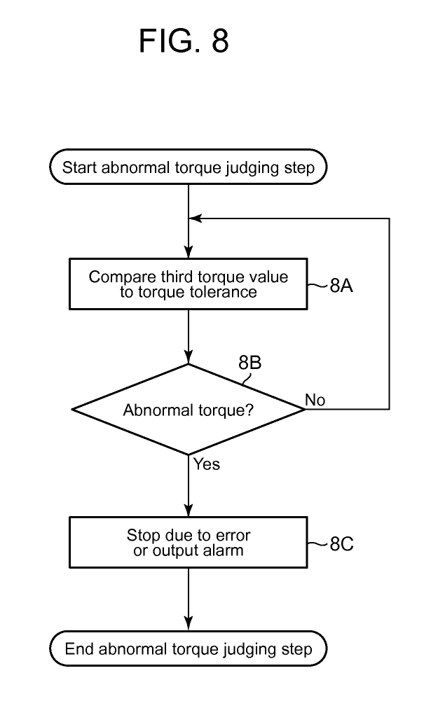

When the torque correction step (2E) is completed in FIG. 2, a transition to the abnormal torque judging step (2F) is made. Hereinafter, processing by the motor control apparatus 1 in the abnormal torque judging step (2F) will be described by using FIG. 8.

Torque tolerances based on the third torque value are set in advance by the user as the abnormality detecting parameters. Two torque tolerances are set, i.e. a torque tolerance for stopping due to an error in order to stop the motor 15 for the purpose of preventing the breakdown of the motor 15 and a torque tolerance for outputting an alarm in order to output an alarm to the user when a slight degree of abnormal torque is generated which is not serious enough to stop the motor 15. Also, the alarm-outputting torque tolerance is set to be closer in value to the third torque value calculated in the torque correction step (2E) than the error-stopping torque tolerance.

Which value is to be used as the torque tolerance can be selected by the user from a value calculated by multiplying the third torque value by a certain scale factor and a value calculated by adding/subtracting a certain value to/from the third torque value. In addition, by setting an upper limit and lower limit for the third torque value as the torque tolerance, abnormality in which an actual torque exceeds tolerance for a torque command value outputted to the motor 15 by the motor control apparatus 1 as well as abnormality in which an actual torque underruns the tolerance can be detected. Note that, as factors for abnormality in which the actual torque decreases, assumed is a case in which torque is insufficiently loaded due to a physical breakage of a machine although the torque is to be loaded to the motor 15, a case in which torque instantaneously decreases due to a reaction against an overload, or the like.

Also, a scale factor by which the third torque value is multiplied or a certain value to be added to/subtracted from the third torque value can be set by the user to an arbitrary value as the abnormality detecting parameters within a predetermined range based on an absolute maximum rating of the torque tolerance of the motor 15.

In addition, torque tolerance can be set independently by the user corresponding to each of the acceleration state, constant speed state, and deceleration state of the motor 15. For example, values calculated by multiplying the third torque value by certain scale factors may be used as torque tolerance in the acceleration state and deceleration state of the motor 15, and values calculated by adding/subtracting a certain value to/from the third torque value may be used as torque tolerance in the constant speed state of the motor 15. That is, preferred torque tolerance appropriate for operating conditions can be set by changing a method of determining torque tolerance in accordance with operating states of the motor 15.

Next, in accordance with a predetermined sampling cycle, the second torque value calculated in the operation step (2D) is compared in Step 8A to the upper limit and lower limit of the torque tolerance which are obtained based on the third torque value calculated in the torque correction step (2E), whereby whether or not a torque of the motor 15 in operation is within a torque tolerance range set in the previous step is judged in Step 8B.

Next, processing for stopping the motor 15 due to an error or for outputting an alarm outside of the motor control apparatus 1 is performed in Step 8C by the motor control apparatus 1. Concretely, if the second torque value of the motor 15 in operation deviates from the range of the error-stopping torque tolerance, a control for free run stopping or deceleration stopping is immediately performed for the motor 15 by the motor control apparatus 1. Furthermore, whether to stop the motor 15 by a free run or by a deceleration can be set in advance by the user in the abnormality detecting parameters. Here, concurrently with the above described control, information that the motor 15 is stopped due to an error and a frequency and torque value when the motor 15 stopped due to an error are displayed on the display unit 12. In this case, by making it unable to restart the motor 15 without resetting the motor control apparatus 1, the motor control apparatus can be made fail-safe.

Meanwhile, when the second torque value of the motor 15 in operation deviates from the range of the alarm-outputting torque tolerance, but stays within the error-stopping torque tolerance, an alarm informing that the torque of the motor 15 deviates from the range of the alarm-outputting torque tolerance and a frequency and torque value when it happened are displayed on the display unit 12 by the motor control apparatus 1.

When the second torque value of the motor 15 deviates from the range of the alarm-outputting torque tolerance or deviates from the range of the error-stopping torque tolerance, an output signal level from the terminal 13 is changed by the motor control apparatus 1, so that a state of the motor 15 can be checked by the user by using a measuring instrument such as a Memory HiCorder. After the completion of the above described processing, the abnormal torque judging step is completed.

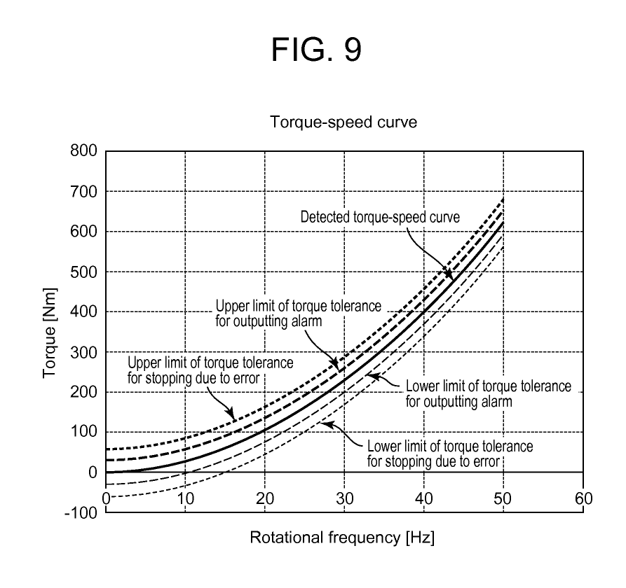

FIG. 9 shows an example of curves for representing a relationship among a torque-speed curve detected by the motor control apparatus 1, an upper limit and lower limit of a error-stopping torque tolerance, and an upper limit and lower limit of a alarm-outputting torque tolerance. As shown in FIG. 9, since an upper limit and lower limit of a error-stopping torque tolerance and an upper limit and lower limit of a alarm-outputting torque tolerance are detected in the trial operation step (2B) and are set in the data processing step (2C) for the respective speeds in Embodiment 1, it is effective for protecting the machine because abnormality of the motor can be promptly and accurately detected.

As described above, in a power converter according to Embodiment 1, a torque value and a speed value of a motor detected from the motor in operation in accordance with a predetermined sampling cycle are compared in an abnormal torque judging step to an upper limit and lower limit of a error-stopping torque tolerance and an upper limit and lower limit of a alarm-outputting torque tolerance which are detected in a trial operation step and are set in a data processing step. As a result, since the motor is stopped if the detected torque value exceeds the upper limit or underruns the lower limit of the error-stopping torque tolerance, it is effective for protecting machines because abnormality of the motor torque can be promptly and accurately detected within an entire range of speeds including a lower speed range.

### REFERENCE NUMERALS

1: motor control apparatus, 2: speed controller, 4: abnormal torque judging unit, 5: current/speed detector, 7: table generator, 9: table memory section, and 11: torque correction unit.

1-5. (canceled)

6. A control method for a motor control apparatus comprising:
a trial operation step for trially operating a motor, detecting a current value flowing to the motor and a speed value of the motor, and calculating a first torque value by using the current value;
a data processing step for performing data processing on speed values of the motor detected in the trial operation step and first torque values calculated in the trial operation step;
an operation step for operating the motor, detecting a current value flowing to the motor and a speed value of the motor, and calculating a second torque value by using the current value;
a torque correction step for correcting, based on the speed value of the motor detected in the trial operation step and the first torque value, to obtain a third torque value at the speed value of the motor detected in the operation step; and
an abnormal torque judging step for judging, by comparing the second torque value calculated by the speed value of the motor detected while the motor is in operation and the torque calculator to torque tolerance which is calculated based on the third torque value, whether or not the second torque value exceeds an upper limit or underruns a lower limit of the torque tolerance; wherein the data processing step includes:
a step for separating the speed values of the motor and the first torque values into data in an acceleration state, data in a constant speed state, and data in a deceleration state;
a step for sorting the speed values of the motor and the first torque values in ascending order of the speed value of the motor;
a step for generating tables based on the respective data; and
a step for calculating torque tolerance based on a first torque value stored in one of the tables.

7. (canceled)
